(19) United States
(12) Patent Application Publication
(10) Pub. No.: US 2014/0337155 A1
(43) Pub. Date: Nov. 13, 2014

(54) Systems and Methods for Implementing Heuristic-Based Auctions

(71) Applicant: AUCTIONOMICS, INC, Palo Alto, CA (US)

(72) Inventors: Paul Robert Milgrom, Stanford, CA (US); Ilya Segal, Stanford, CA (US); Jonathan Levin, Stanford, CA (US)

(73) Assignee: Auctionomics, Inc, Palo Alto, CA (US)

(21) Appl. No.: 13/892,126

(22) Filed: May 10, 2013

(51) Int. Cl. G06Q 30/08

(52) U.S. Cl. CPC G06Q 30/08
USPC 705/26.3

(57) ABSTRACT

The present invention is directed to systems and methods for implementing heuristic-based auctions for complex resource allocations. The systems and methods include an auctioneer's system that uses a bid-entry device comprising a dedicated system for each bidder to collect bid information and a mechanism by which the auctioneer may communicate results or current prices to bidders in a dynamic process. The auctioneer's system may be coupled to a database that stores information about the items for sale including bid information. The auctioneer's system may be configured to query this database and receive answers with information required to determine allocations and prices. The auctioneer's system may also be coupled, via a communication link, to one or more feasibility-checker systems, comprising a parallel array of one or more computing systems that implements the feasibility-checking process at any given round in a dynamic implementation or any computational iteration in a sealed-bid implementation.

### BACKGROUND OF THE INVENTION

1. Field of the Invention

The present invention relates to improving auctions for complex resource allocations and, more particularly, to implementing such auctions through the use of a plurality of CPU-based systems.

2. Description of the Related Art

A central economic function of auctions is often to solicit relevant information from bidders to help a system pick an optimal allocation or assignment according to criteria that may be defined by the auctioneer. A simple example is an auction scenario conducted to sell or buy an item for cash. In the latter scenario, an auctioneer conducting the auction may simply buy the item from a lowest bidder, who often may also be the bidder with the lowest cost for supplying the item. There are also other examples of auctions that are implemented for addressing much more complicated resource-allocation problems. Examples of these types of auctions include “combinatorial” auctions, which are conducted for the purchase or sale of collections of items, where the packages of items that are bought or sold, in combination, constitute a “good” allocation. In a “procurement” auction, the winning sellers' packages of items, taken together, must be adequate to supply the total quantities that are to be procured.

The most difficult auction problems, in computational terms, often result from situations where the auctioneer, in addition to deciding which items to buy or sell, must make “auxiliary” decisions to determine which combinations of bids are feasible or desirable. For example, if rights to fly in congested airspaces were to be sold by auction, determining whether a set of flights is jointly feasible may require evaluating additional crucial decisions. These might include scheduling decisions about “take-off” times and routes, and would typically be subject to many constraints, such as ones that the schedules must maintain safe distances among different flights or between flights and space launches. Yet another example of a significant problem is when a particular government seeks to buy broadcast television licenses from owners or licensees in order to reorganize the spectrum and free some of it for alternative uses, possibly to include wireless broadband. As part of this reorganization, the particular government may seek to reassign the remaining broadcasters—those who do not sell their licenses—to channels in a way that uses a smaller set of frequencies, in order to leave the complementary set available for new services. In a large country such as the United States, determining whether it is feasible to accept a set of bids while assigning those who do not sell to a small set of channels requires making many thousands of assignment decisions of the kind “should station XYZ be assigned to frequency ABC,” which may be subject to tens or hundreds of thousands of non-interference constraints. An auction problem is referred to as “complex” if checking the feasibility or desirability of a set of bids requires examining a set of auxiliary decisions.

Auction systems can help to improve resource allocation by allowing allocations to be based on bidders' values. In the airspace allocation example, one airline may place a high value on late afternoon flights from New York to Florida, while conflicting plans for space launches from Florida might be replaced by a wide range of other launch times and locations. In contrast to utilizing non-auction methods like rationing and queuing, auctions determine allocations in a way that is sensitive to such values. However, even given value information, finding an optimal allocation that is subject to so many constraints, particularly complex constraints involving other decisions, may be computationally infeasible in the time available for conducting the auction.

For these reasons, there is a dire need to create new auction designs that are based on procedures that are developed to run feasibly and address complex resource allocation problems in the time allotted, however short that may be. The most useful procedures are often heuristic procedures, which are not guaranteed to produce optimal solutions for all the problems in their domain but which may nevertheless produce quick and acceptably sound solutions.

Often, one of the most important characteristics of an auction design is the cost that it imposes on bidders who participate. In order to encourage as many bidders as possible to participate, there is an advantage to setting auction rules that make bidding simple and inexpensive for bidders, even when the inherent complexity of the resource allocation problem makes the overall procedure unavoidably complex. The theoretical ideal is a “strategy-proof” auction—an auction in which the optimal way to bid can be determined without reference to the likely strategies adopted by other bidders—because that can drastically reduce the cost and increase the safety of bidding, allowing participants to avoid spending effort on competitor analysis or strategic analysis, while still being confident of their ability to avoid bidding mistakes. Even when auctions that are strategy-proof for all participants are too costly or difficult to implement, it may still be possible and desirable to conduct an auction that is strategy-proof or nearly strategy-proof for some of the bidders, in order to keep their costs of participation low. This is particularly important for bidders whose decisions to participate are expected to be key determinants of the auction's success.

Strategy-proof auctions sometimes have sealed-bid and dynamic versions that are strategically equivalent. For example, consider a situation in which a buyer wishes to purchase a single good or item up to a maximum price of “M” and each potential seller knows its minimum price for supplying that good. In that setting, the sealed-bid auction known as the “second-price auction” is essentially strategy-proof. In a second-price auction, the bidder who submits the lowest sealed-bid price “P” wins the right to supply the item and receives a price equal to the smaller of “M” or the second-lowest sealed bid price. The second-price auction is strategy-proof because a bidder/buyer whose minimum price for the item is “X” always achieves the best possible outcome for itself by submitting a bid price of “P=X,” regardless of what bids others may make. There is also a dynamic auction that is strategically equivalent to the second-price auction. In the equivalent dynamic auction, tentative prices are set over time and displayed to bidders in some way, for example, on a computer screen or on a device resembling a digital clock. The displayed price starts at “M” and declines over time, and bidders in this auction are not given any information about one another's actions. During the auction, the price displayed falls continuously or with small decrements and bidders may exit at any time during the auction. The auction ends immediately when there is just one bidder remaining; that bidder wins the item and pays the price that is displayed on the price clock at the end. In this dynamic auction, a bidder's strategic decision is to plan the price “P” at which it will exit the bidding. The winner will be the bidder who chooses the lowest exit price “P” and the final price will be the smaller of “M” or the second lowest exit price. In the language of game theory, this dynamic game is strategically equivalent to the second-price “sealed-bid” auction because both involve the same strategic decision, namely, choosing a minimum price, and both lead to the same mapping from strategic decisions to winners and prices.

The preceding example illustrates a principle about the equivalence or near-equivalence of certain sealed-bid and dynamic auction procedures. Generally, the economic content of an auction procedure is described by three main elements: (1) the bid-collection procedure, which can be either a sealed-bid procedure or a dynamic procedure, (2) a winner determination procedure to decide which bids are winning, and (3) a pricing procedure that specifies the price to be paid or received for each winning bid. Dynamic auctions gather information gradually and sometimes economize on communications for that reason. In the example described above, bidders in a “sealed-bid” auction reveal all the information about their values, but in a “descending clock” auction, they reveal just enough to determine the allocation. It is elements (2) and (3) above, however, that are the key to conclusions about strategy-proof auctions, and those elements may be either nearly or exactly the same in sealed-bid and dynamic auctions.

The strategy-proof reverse auctions described above are referred to as “threshold” auctions, which means, first, that a bidder is a winner if it bids according to a minimum price that is less than a threshold “T,” which is determined by the other bidders' bids, and, second, that the winners pays an amount equal to “T.” In the “second-price” auction, “T” is equal to the lowest of the bids among the other bidders. We describe some other strategy-proof auctions with threshold pricing rules below, both in the prior art and in a preferred version of this invention.

Existing auctions that are successful for many applications require speed of computation to address computationally hard resource-allocation problems and ensure exact or approximate strategy-proofness; in fact, these key requirements have inspired research on fast, strategy-proof auction designs for computationally hard problems. In an early contribution, Lehmann, O'Callaghan and Shoham (2002) (“Truthful Revelation in Approximately Efficient Combinatorial Auctions,” Journal of the ACM, Vol 49, No. 5, pp. 577-602) introduced a “sealed-bid” auction based on a “forward” greedy heuristic: in their approach, the greedy heuristic orders the bids and then adds winning bids one at a time, but skips over bids which, if accepted, would result in the total demand exceeding the available supply. Different greedy heuristics are distinguished by the criterion used for ordering the bids. In this design that is described, the order of bid processing is determined once and for all before the individual bids are processed. The use of the greedy heuristic ensures speed for a combinatorial auction problem with simple quantity constraints. The same paper also proposes using a threshold pricing rule, which results in an auction design that is strategy-proof for what the paper calls single-minded bidders, defined as those who are interested in buying just one particular package of items and have no value for any other package.

Yet another approach is proposed by Ensthaler and Giebe (2009) (“Subsidies, Knapsack Auctions and Dantzig's Greedy Heuristic,” working paper, Humboldt University), which describes a “dynamic” auction to be used by a buyer who is seeking to choose among sets of goods of various levels of quality. The buyer has a single constraint, which is a limit on its available budget. That paper describes a “descending clock” auction, in which the price displayed to each bidder at any moment is the price then offered per unit of quality multiplied by the bidder's quality index. During the auction, prices decline continuously. At any time, any bidder may choose to withdraw its item and exit the auction. For bidders who have not withdrawn, the displayed prices continue to decline until the first moment when the sum of the prices for items that are not withdrawn no longer exceeds the buyer's budget. The auction then ends, the bids that are not withdrawn are declared to be winning bids, and the winning sellers are paid the final display prices for their items. In contrast to the forward greedy heuristic used by Lehmann, O'Callaghan and Shoham (2002) in which bids are accepted one at a time and bids that have not been accepted when the auction ends become rejected, the Ensthaler and Giebe (2009) descending clock auction corresponds to a reverse greedy heuristic, in which bids are rejected one at a time and bids that have not been rejected when the auction ends become accepted. If each seller has just one package to offer, then the Ensthaler and Giebe (2009) procedure describes a “strategy-proof” auction.

Milgrom (2008) (“Assignment Exchange and Auction,” application Ser. No. 12/340,999) teaches a sealed-bid auction procedure that computes assignments and threshold prices for a class of multi-product allocation problems in which a particular reverse greedy heuristic can identify exactly optimal solutions and market-clearing prices. This sealed-bid auction design also has a nearly equivalent clock auction implementation. If each seller has just one item to offer, the Milgrom (2008) procedure describes a strategy-proof auction. It can also apply and be nearly strategy-proof in exchange situations, in which some bidders are buyers and others are sellers.

Strategy-proof auctions based on reverse greedy heuristics have an additional property that auctions based on ordinary greedy heuristics do not: such auctions are group strategy-proof. This means that, in addition to having the ordinary strategy-proof property that no single bidder can increase its payoff by bidding an amount different from its true value, the auction also has the property that no group of bidders can make a coordinated change in their bids that strictly increases the payoff of all group members. This observation highlights the important distinction between forward and reverse greedy heuristics in auction design.

Each of these heuristic-based prior designs that exist has a limited domain of applicability that excludes what we have called complex auction problems. The Ensthaler and Giebe clock auction applies to situations in which there is just a single constraint, which is the overall budget. This budget-constraint limitation eliminates complex auction problems and makes it possible simultaneously (1) to select as winners of the bids with the lowest price/quality, (2) to pay the same price/quality to every winning bid, and (3) to make the resulting combination strategy-proof. The Lehmann, O'Callaghan and Shoham sealed-bid auction also assumes a simple form for the relevant constraints, in which total demand is limited by total supply, which eliminates complex auction problems. While that auction is able to incorporate a class of greedy heuristics, it explicitly limits attention to ones in which the order of processing of bids can be determined before any bid processing begins. In the problems of allocating airspace and radio spectrum described above, determining feasibility is much harder, because the constraints are complex: the auction must consider many more variables than just the allocation itself. In addition, the scoring of bids in complex auctions may be improved by allowing those scores to depend on information that is unavailable before the bid processing begins. The procedure of Milgrom (2008) can be implemented using a particular reverse greedy heuristic, but it is restricted to a particular set of constraints for which the heuristic and optimal solutions coincide and is described only for auction problems that are not complex.

Therefore, new and improved methods are needed to conduct auctions in environments with complex constraints and where complex scoring techniques are beneficial.

### SUMMARY OF THE INVENTION

The present invention overcomes the deficiencies of the prior art with systems and methods that are automated and computerized and configured to run both sealed-bid and dynamic auction processes for complex resource-allocation problems.

Auction problems with auxiliary choices require new methods to accommodate the computational challenges that they create. Just checking whether it is feasible to accept a certain collection of bids in complex auction situations can entail time-consuming computations. In the present invention, the calculations utilize a feasibility checker, which may consist of one or more computer systems that executes a satisfiability checking algorithm (known in the computer science fields as a SAT solver). A SAT solver tries to determine whether it is possible to assign values of true or false to certain logical variables in such a way that a given set of propositions that depend on those variables are all true. For instance, in the spectrum-reorganization problem, each true-false variable may correspond to a decision about whether to assign a particular station to a particular channel. Then, a SAT solver may check whether there is any way to assign values of true or false to each variable in such a way that all of the relevant propositions are true. The relevant propositions may be: (1) that each television station chosen to continue broadcasting is assigned to at least one channel, (2) that no station is assigned to multiple channels, (3) that no two assigned stations have unacceptable interference with one another, (4) that no station's signal interferes with international treaty obligations, and so on. The new methods needed to resolve complex auction problems incorporate feasibility checkers into the auction system and process.

The systems and methods include an auctioneer's system that uses a bid-entry device, which may consist of a dedicated system for each bidder, to collect bid information and a mechanism for the auctioneer to communicate results or, in the dynamic process, current prices to bidders. The auctioneer's system may be coupled to a database that stores information about the items for sale, including bid information. In some implementations, the auctioneer's system is configured to query this database and receive answers with information required to determine allocations and prices. The auctioneer's system is also coupled, through a communication link, to one or more feasibility-checker systems, comprising an external parallel array of one or more computers that implements the feasibility-checking process at any given round (dynamic version) or iteration (sealed-bid version).

Thus, in accordance with one aspect of the present invention, a computer-implemented, heuristic-based, procurement auction system comprises at least two control systems, including an auctioneer system communicatively coupled to one or more feasibility-checker systems, and a bid-entry system that is able to transmit bid information (in a sealed-bid embodiment) or exit decisions (in a dynamic embodiment) to the auctioneer's system and a mechanism for bidders to receive auction-results messages (in a sealed-bid embodiment) or current price information (in a dynamic embodiment) from the auctioneer's system. The auctioneer's system further includes the means to receive and transmit the same information and messages, as well as means to store and update bid information, information about item characteristics, and other information in one or more databases; to query and receive answers from those databases; to make decisions based on those answers about whether the auction should continue and, if not, about how items should be allocated and priced.

In accordance with a second aspect, the present invention is directed to a fast, computerized auction method for conducting complex auctions that utilizes a feasibility checker, which is a process that gives a fast answer—“yes,” “no,” or “undecided”—to many questions about whether a set of conditions can be satisfied by adjusting certain variables.

A method of the present invention may be configured to comprise the following steps: initiating an auction, including collecting bid/item information from one or more bidders; entering bid/item information in one or more databases; evaluating updated information and determining whether an auction should end and; if not, generating updated provisional price or allocation decisions based on current information in database(s), in particular, using a feasibility-checking process to evaluate each item at each round or iteration to provisionally determine whether it can feasibly be included in the final allocation and, if so, using a scoring-function process to determine for each item, at each round or iteration, whether (in the “sealed-bid” embodiment) it should be rejected (i.e., not included in the final allocation) or (in the dynamic embodiment) what price should next be offered/displayed to the bidder; communicating updated information or final messages to one or more bidders, and repeating steps selected from among the above, until it is determined that the auction should end.

In accordance with a third aspect, the present invention relates to an implementation of a procurement auction for allocating items in an environment with complex constraints.

The features and advantages described herein are not all-inclusive and many additional features and advantages will be apparent to one of ordinary skill in the art in view of the figures and detailed description that follows. Moreover, it should be noted that the language used in the specification has been principally selected for ease of comprehension and instructional purposes, and not to limit the scope of the inventive subject matter.

### BRIEF DESCRIPTION OF THE DRAWINGS

The invention is illustrated by way of example, and not by way of limitation in the figures of the accompanying drawings, in which like reference numerals are used to refer to similar elements.

FIG. 1 is a block diagram illustrating an example auction system that may be used to conduct a sealed-bid auction.

FIG. 2 is a block diagram illustrating an example auction system that may be used to conduct a dynamic auction.

FIG. 3 is a block diagram illustrating an example system that may be used to run a parallelized feasibility-checking process.

FIG. 4 is a block diagram illustrating one embodiment of the auction system described in FIGS. 1 and 2.

FIG. 5A is a flowchart illustrating an example auctioneer process for conducting a sealed-bid auction.

FIG. 5B is a flowchart illustrating an example auctioneer process for conducting a dynamic auction.

FIG. 5C is a flowchart illustrating an example bidder process for conducting a sealed-bid auction.

FIG. 5D is flowchart illustrating an example bidder process for conducting a dynamic auction.

FIG. 6 is a flowchart illustrating one implementation of the sealed-bid “reverse greedy heuristic” auction process.

FIG. 7 is a flowchart illustrating one implementation of the dynamic “reverse greedy heuristic” auction process.

FIG. 8 is a flowchart illustrating subroutines within example processes described in FIGS. 6 and 7, including the feasibility checker and the auction-ending rule.

FIG. 9 is a flowchart illustrating an example feasibility-checking process for each item at each round or iteration of an auction.

### DETAILED DESCRIPTION OF PREFERRED EMBODIMENTS

Systems and methods for implementing improved auctions for complex resource allocations through the use of a plurality of CPU-based systems are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to specific auctions. However, the present invention applies to any type of computing system and data processing for implementing an exchange or auction.

Reference in the specification to “one embodiment or implementation” or “an embodiment or implementation” means simply that a particular feature, structure, or characteristic described in connection with the embodiment or implementation is included in at least one embodiment or implementation of the invention. The appearances of the phrase “in one embodiment or implementation” in various places in the specification are not necessarily all referring to the same embodiment or implementation. In particular, the present invention is described below in the context of two distinct architectures and some of the components are operable in both architectures while others are not.

Some portions of the detailed descriptions that follow may be presented in terms of algorithms and symbolic representations of operations performed on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatuses to perform the required method or process steps or operations. The required structure for a variety of these systems will appear from the description below. In addition, the present invention is described without reference to any particular programming language. It will be appreciated that a variety of programming languages may be used to implement the teachings of the invention as described herein.

### System Architecture Overview

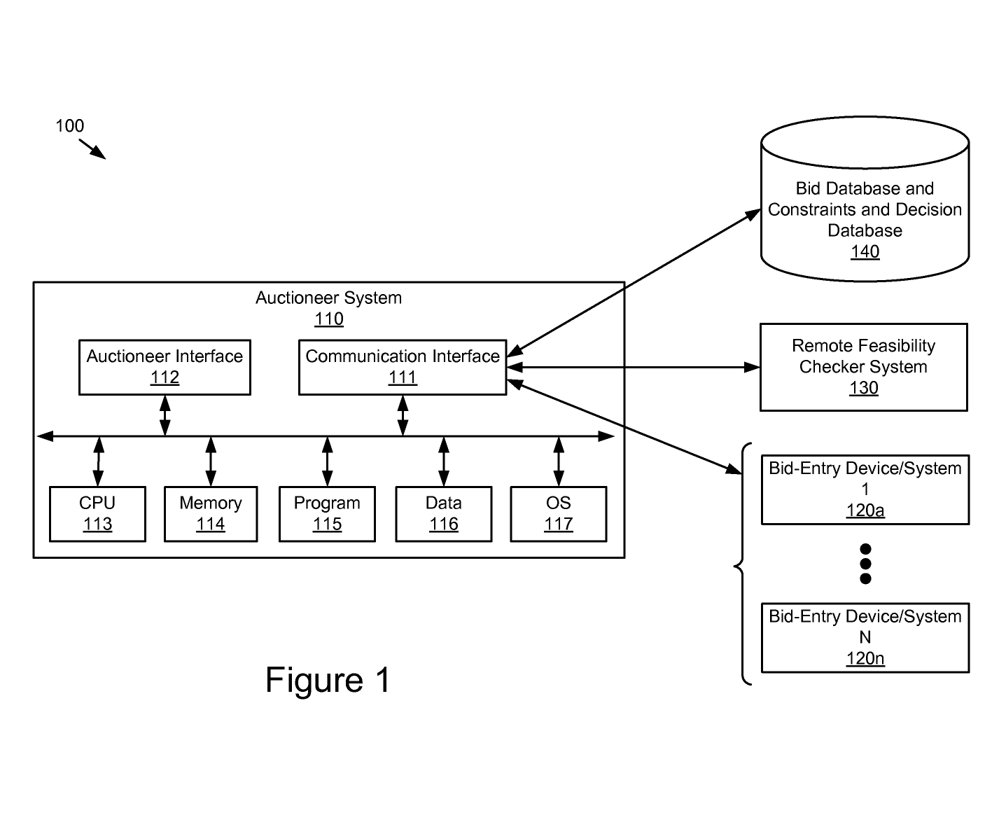

Referring to FIG. 1, in accordance with some implementations, the system of the present technology runs a “sealed-bid reverse” auction using a “heuristic” that is referred to as a reverse greedy heuristic, which is a procedure for deciding on an allocation by iteratively building a set of bids to reject and accepting the bids that remain when no more bids may be rejected. A possible implementation of an auction in which bidders are sellers—a so-called “reverse” auction—is described here. It will be obvious to those skilled in the art that similar procedures apply also to “forward” auctions.

The present invention is directed to an auction system and methods for implementing a heuristic-based complex auction that is a mechanism for use in assigning and pricing multiple goods or products or varieties of a good or product. While the present invention is described below in the context of goods, those skilled in the art should recognize that the system and method of the present invention can be used for services or any other exchangeable item. The auction system disclosed here applies to settings in which there are a certain number of varieties of a good that are offered for sale or otherwise.

The heuristic-based procurement system of the present invention is particularly advantageous because it provides a mechanism that accommodates complex transactions.

FIG. 1 shows one embodiment of example data structures and data for conducting a “sealed-bid” auction system as indicated generally by reference numeral 100. In this example, an auctioneer system 110 comprises an auctioneer interface 112, coupled to a communication interface 111, a CPU 113, and a memory 114 comprising a program or several programs indicated by reference numeral 115, data indicated by reference numeral 116 stored in the memory 114, and an operating system (“OS”) 117. It should be recognized that the lines as illustrated in the drawing figures connect each of the blocks that represent system components or elements and functionalities, where the lines represent flow of either signals or data in either direction as necessary to the operation of the system components or elements illustrated. As is common in most auctions, either one or more sellers make offers or one or more buyers make bids on lots or commodities. Throughout the description below, the term “lot” is used to denote the unit being exchanged, purchased, or priced. It should be recognized that a lot may be an item, a good, a service, a combination of a good and a service, a product, a collection of goods, a collection of services, a combination of a collection of goods and a collection of services, or any other combinations of the previously listed.

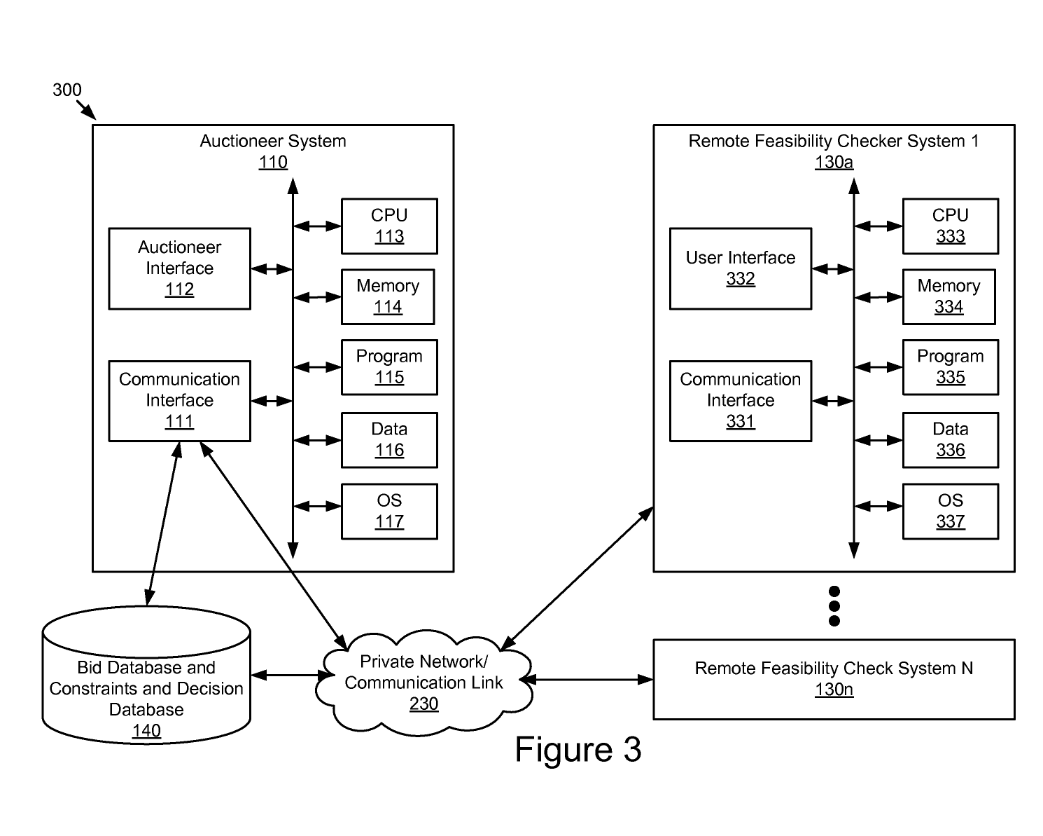

The auctioneer system 110 is coupled to a bid-entry device (one or more indicated as 1 through N) indicated by reference numeral 120. The communication interface 111 may be coupled to a remote feasibility-checker system indicated by reference numeral 130 (described in detail in the description of FIG. 3 below). Remote feasibility-checker (“F.C.”) systems 1 through N are illustrated in FIG. 3 with their configuration of components or elements. Referring now to FIG. 3, each of the remote F.C. systems 1 through N (indicated by reference numeral 130) may comprise a user interface 332 coupled to a communication interface 331, which is coupled to a CPU 333. The CPU 333 is coupled to a memory 334, a program or programs 335, data 336, and an operating system (“OS”) 337. Referring again to FIG. 1, the communication interface 111 (of the auctioneer system 110) is also coupled to a bid database and constraints and decisions database 140.

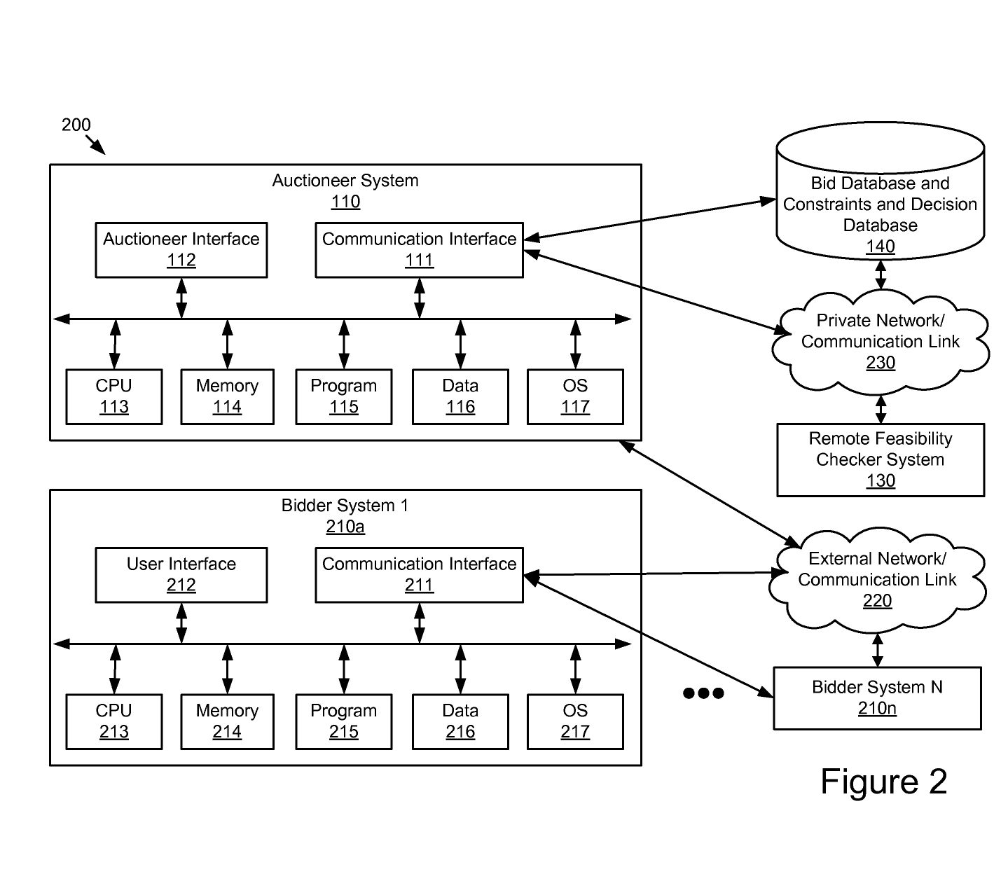

FIG. 2 shows an embodiment of an example dynamic implementation of the auctioneer system 110 indicated here generally by reference numeral 200. In this example, an auctioneer system 110 (as illustrated in FIG. 1) may comprise an auctioneer interface 112, coupled to a communication interface 111, a CPU 113, and a memory 114 comprising a program or programs 115, data 116 stored in the memory 114, and an operating system (“OS”) 117. As in most auctions either one or more sellers make offers or one or more buyers make bids on lots or commodities. Throughout the description below, the term “lot” is used to denote the unit being exchanged, purchased, or priced. It should be recognized that a lot may be an item, a good, a service, a combination of a good and a service, a product, a collection of goods, a collection of services, a collection of goods and a collection of services, or any other combinations of the previous.

The auctioneer system 110 is coupled to either a bid-entry device (as in FIG. 1) or bidder system 1 through bidder system N indicated by reference numeral 210 (FIG. 2) as illustrated in this implementation. The communications interface 111 (of the auctioneer system 110) is coupled through a private network/communication link 230 to a remote Feasibility-Checker System (F.C.) indicated by reference numeral 130. Referring again to FIG. 3, each of the remote F.C. systems 1 through N, also comprises a user interface 332 coupled to a communication interface 331, which is coupled to a CPU 333. The CPU 333 is coupled to a memory 334, a program or programs 335, data 336 stored in the memory 334, and an operating system (“OS”) 337. Referring again to FIG. 2, the communication interface 111 is also coupled to a bid database and constraints and decisions database 140.

Referring to FIG. 2, bidder systems 1 through N, indicated by reference numeral 210, are coupled to an external network/communication link 220. As one example, the bidder system 1 (210) comprises a user interface 212, which is coupled to a communications interface 211. The communications interface 211 is coupled to a CPU 213, which is coupled to a memory 214, a program or several programs indicated by reference numeral 115, data 116, and a operating system (“OS”) 117. Each of the other bidder systems N (210) may be configured in the same manner or with some variations as desired, yet configured to perform the functionalities described here.

Referring again to FIG. 3, it should be noted that it illustrates the remote feasibility-checker system as indicated generally by reference numeral 300. The communication interface 111 of the auctioneer system 110 may be coupled to remote F.C. systems 1 through N indicated by reference numeral 130 through a private network/communication link indicated by reference numeral 230 (similar to or different from the external network/communications line 220 illustrated in FIG. 2). Each of the remote F.C. Systems 1 through N indicated by reference numeral 130 are configured with the user interface 332 coupled to the communication interface 331, which is coupled to the CPU 333. The CPU 333 is coupled to the memory 334, the program 335, data 336, and the operating system (“OS”) 337. The F.C. systems 1 through N as indicated by reference numeral 130 are also coupled, through a private network/communication link 230, to the bid database and constraints and decisions database 140, which is coupled to the communications interface 111 of the auctioneer's system 110.

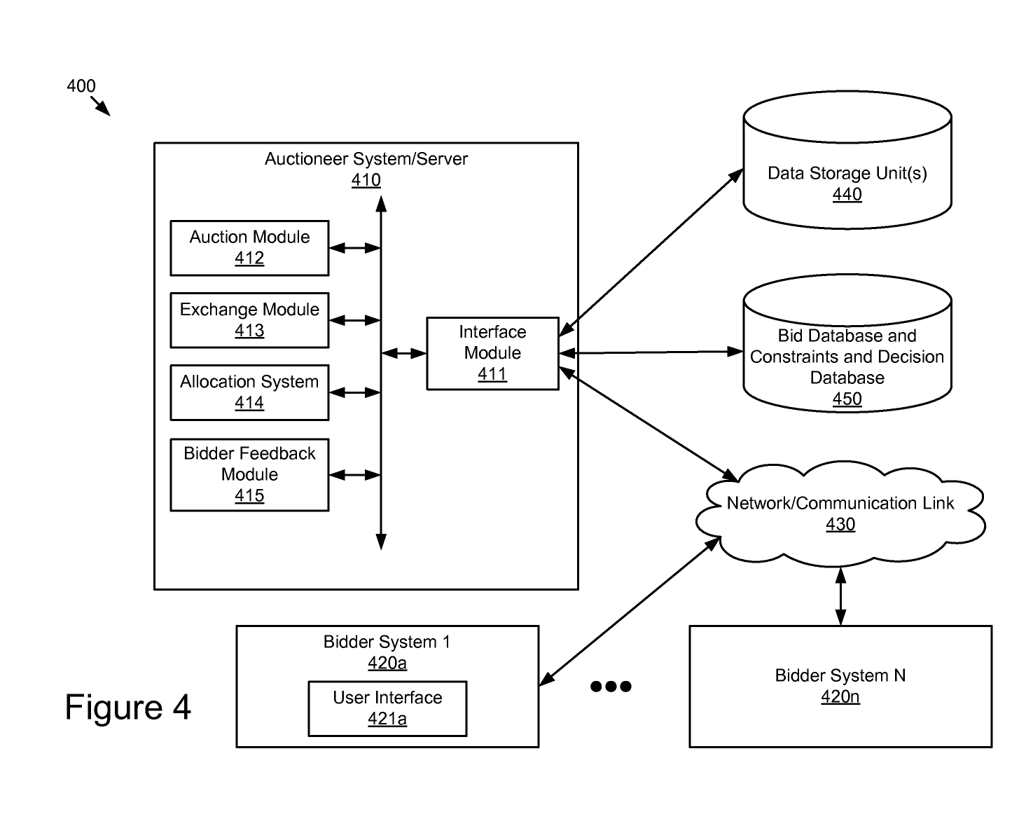

FIG. 4 illustrates one embodiment of the auctioneer system (also illustrated in FIGS. 1, 2, and 3, by reference numeral 110) according to the present invention, which is indicated generally in this figure by reference numeral 400. The auctioneer system 400 may comprise a server 410 (Auctioneer System/Server), a network/communications link 430 (similar to the networks illustrated in the other figures, for example FIGS. 2 and 3, or different), a plurality of bidder systems 1 through N, indicated generally by reference numeral 420, a bid database and constraints and decisions database 450, and one or more data storage units indicated by reference numeral 440.

The server (Auctioneer System/Server) 410 may be a conventional computer (one or more) comprising an interface module 411, an auction module 412, an exchange module 413, an allocation system 414, and a bidder feedback module 415. The server 410 may optionally include one or more input devices and one or more output devices (not separately illustrated). The server 410 may be an apparatus or system configured for performing a sealed-bid or dynamic auction or exchange, for receiving assignment messages, creating and sending reporting messages, for retrieving and storing data sets to and from the data storage units 440. The server 410 may be coupled for communication and interaction with the plurality of bidder systems 1 through N, indicated by reference numeral 420, via the network/communications link 430. The server 410 is also coupled for communication and interaction with the one or more data storage units 440. The server 410 may be hardware capable of executing and performing routines to achieve the functionality described below with reference to the figures.

The interface module 411 may be software and routines executable on the server 410 to create the user interfaces depicted below by way of example. The interface module 411 also controls and handles the communication between the server (auctioneer system) 410 and the plurality of bidder systems 1 through N, indicated in this figure by reference numeral 420. The interface module 411 also controls the exchange of data between the one or more data storage units 440, the auction module 412 (configured to conduct either sealed-bid or dynamic auctions), the exchange module 413, the allocation system 414, and the bidder feedback module 415. In one embodiment, the interface module 411 may be responsible for receiving assignment messages and translating them into a data format usable by the other components of the server 410. The interface module 411 may also be responsible for creating and sending reporting messages to the plurality of bidder systems 1 through N, as indicated by reference numeral 420.

The auction module 412 (for conducting sealed-bid or dynamic auctions) may be software and routines executable on the server 410 to operate and run one or more sealed-bid auctions iteratively. In one embodiment, the auction module 412 may be adapted for interaction and communication with the interface module 411 and the allocation system 414 during operation of the auction. The auction module 412 controls the receipt of bid groups and cooperates with the allocation system 414 to determine a winning bid group and close-to-winning bid group and send out notification messages. The module 412 also cooperates with the interface module 411 to receive and store data sets relating to the auction that are transmitted to and received from the data storage units 440.

The exchange module 413 may be software and routines executable on the server 410 to operate and run an exchange. In one embodiment, the exchange module 413 is adapted for communication and interaction with the interface module 411 and the allocation system 414 for operation of the exchange. The exchange module 413 controls the receipt of bid groups and cooperates with the allocation system 414 to determine a list of winning bid groups and close-to-winning bid groups and sends notification messages to the bidder systems 1-N as indicated by reference numeral 420. The exchange module 413 also cooperates with the interface module 411 and is configured to receive and store data sets relating to the exchange that are transmitted to and received from the data storage units 440.

The allocation system 414 may be software and routines executable on the server 410 to determine an allocation of lots that maximizes a total money value for a plurality of bid groups subject to one or more constraints. As noted above, the allocation system 414 may be configured to cooperate with the auction module 412 and/or the exchange module to create a sealed-bid or dynamic auction or exchange, respectively. The operation and components of the allocation system 414 are described below in more detail. The allocation system 414 interacts with the data storage unit 440 via the interface module 411.

The network/communication link 430 may be of a conventional type such as the internet for interconnecting computing and/or communication devices. The network/communication link 430 can be any one of a conventional type such as a local area network (LAN), a wide area network (WAN) or any other interconnected data path across which multiple computing and/or communication devices may communicate.

Each of the bidder systems 1 through N indicated by reference numeral 420 may be one or more computing systems such as a personal computer, a mobile device, or the like, and may include software operable on a general purpose computer or specialized hardware for providing functionality described below. The user interface 421 of the bidder system 420 may be software and a set of routines executable by the bidder systems 1 through N, indicated by reference numeral 420 to provide graphical user interfaces. For example, the user interface 421 includes a module with a conventional type browser such as Internet Explorer® from Microsoft Corporation or Firefox® from the Mozilla Foundation. The user interface module 421 also presents user interfaces as described below and interacts, cooperates, and communicates with the other components.

The bid database and constraints and decisions database 450 may be software and a set of routines executable to collect information related to bids, constraints, and decisions. The information collected includes the actual information used to formulate bids and bid groups, control and provide administrative information for the presentation of data, user accounts, auctions, exchanges, etc. The bid database and constraints and decisions database 450 may be adapted for communication with the user interface 421.

The memory or data storage units 440 may be devices such as a hard disk drive or other storage media. The memory or data storage units are shown as being coupled to the server (Auctioneer system/Server) 410.

### Process Overview

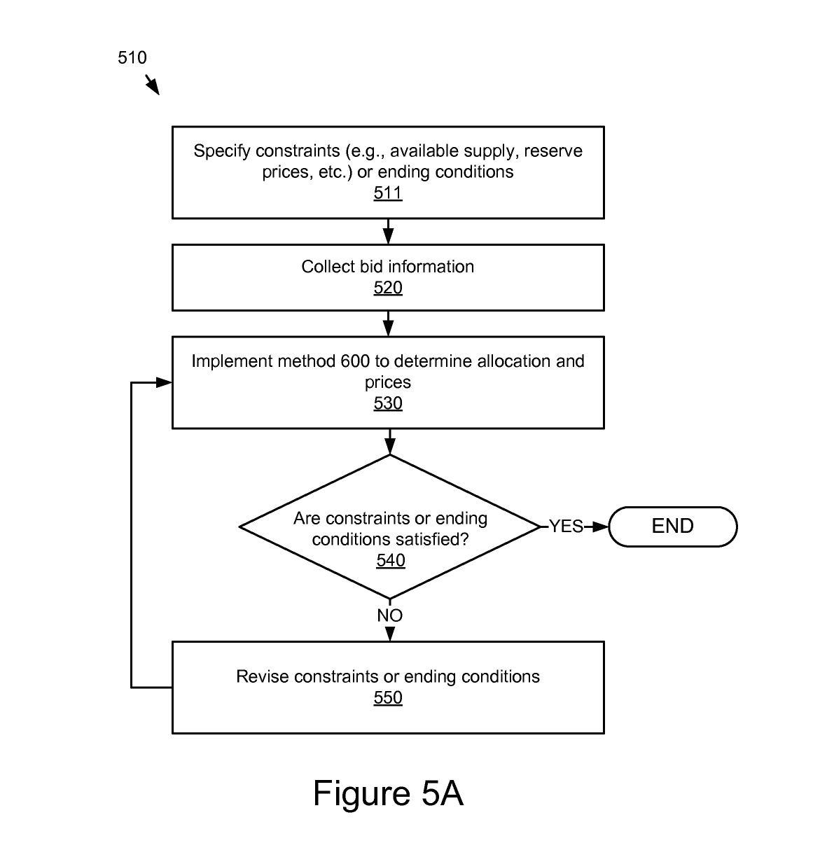

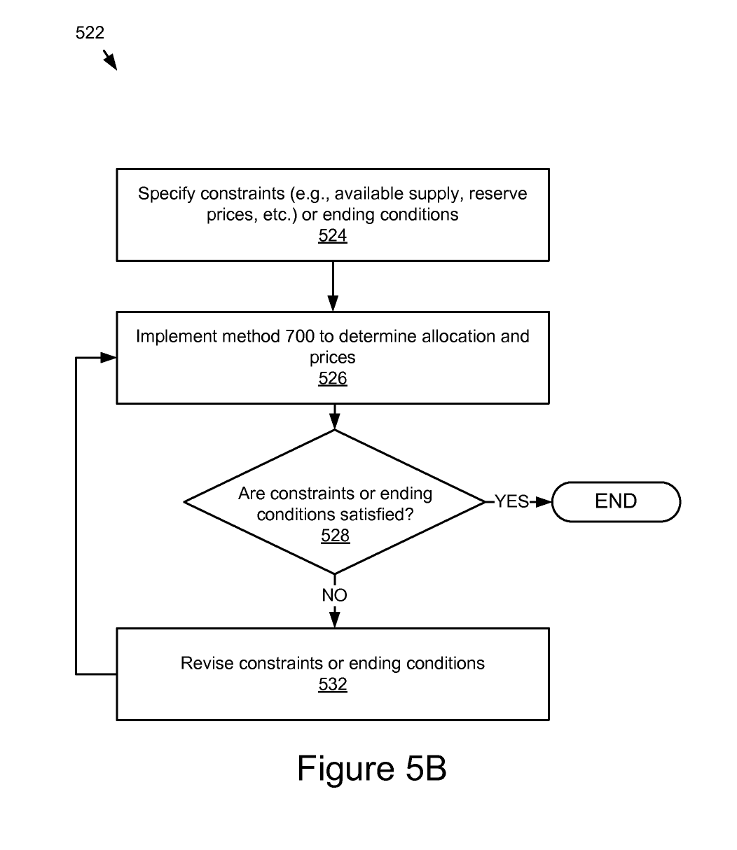

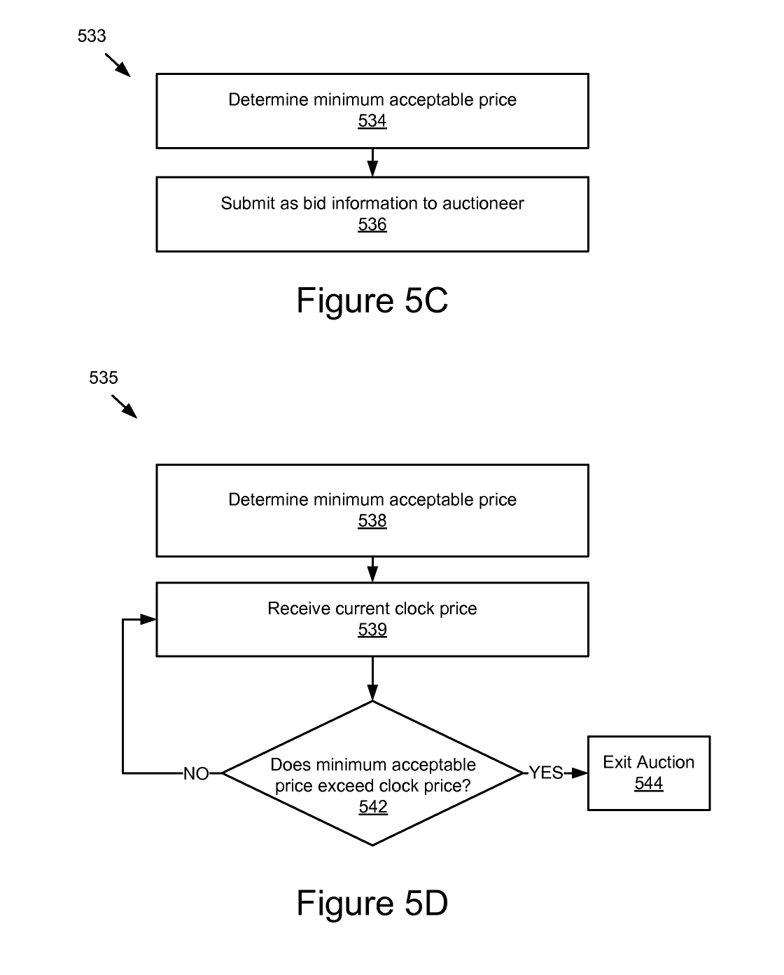

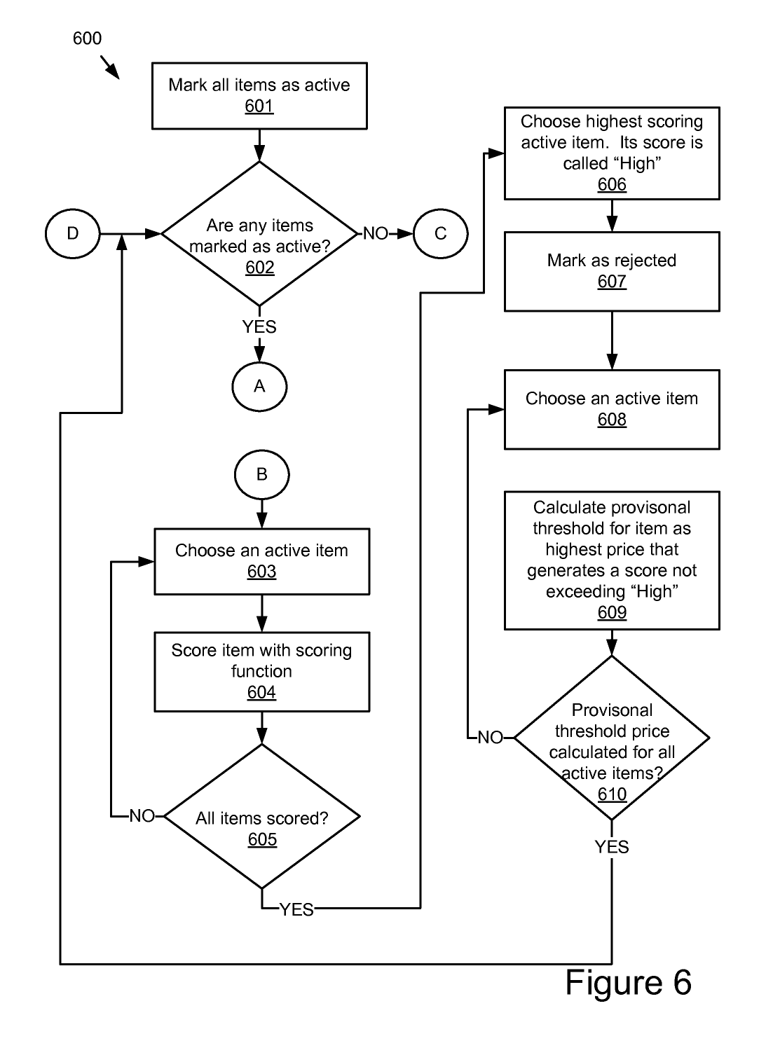

FIG. 5A describes an example auctioneer's process for conducting a sealed-bid auction indicated generally by reference numeral 510. Before an auction is initiated, the process 510 begins with the auctioneer first conducting one or more operations as indicated by block 511 for specifying constraints including, but not limited to, items' reserve prices, the available supply of items, and the conditions under which the auction may end. The process 510 then proceeds to block 520 (including one or more operations), at which point it collects bid information from bidders provided via one or more bid-entry devices (FIG. 1). The one or more bid-entry devices may be implemented in one or more user systems (e.g. as part of them or associated with them). The process 510 then proceeds to block 530, which includes one or more operations for implementing a method 600 (described in greater detail in FIG. 6 below) to determine allocations and prices for the items. The process 510 then proceeds to a decision block 540, at which point, if the constraints specified by the auctioneer in step 511 are met or satisfied, the process 510 proceeds to a point 560 (including one or more operations) at which stage the auction ends. If the constraints are not met or satisfied, the process 510 proceeds to block 550, at which stage the auctioneer relaxes the constraints (e.g., revises the constraints or ends the conditions), and then the process 510 returns to block 530.

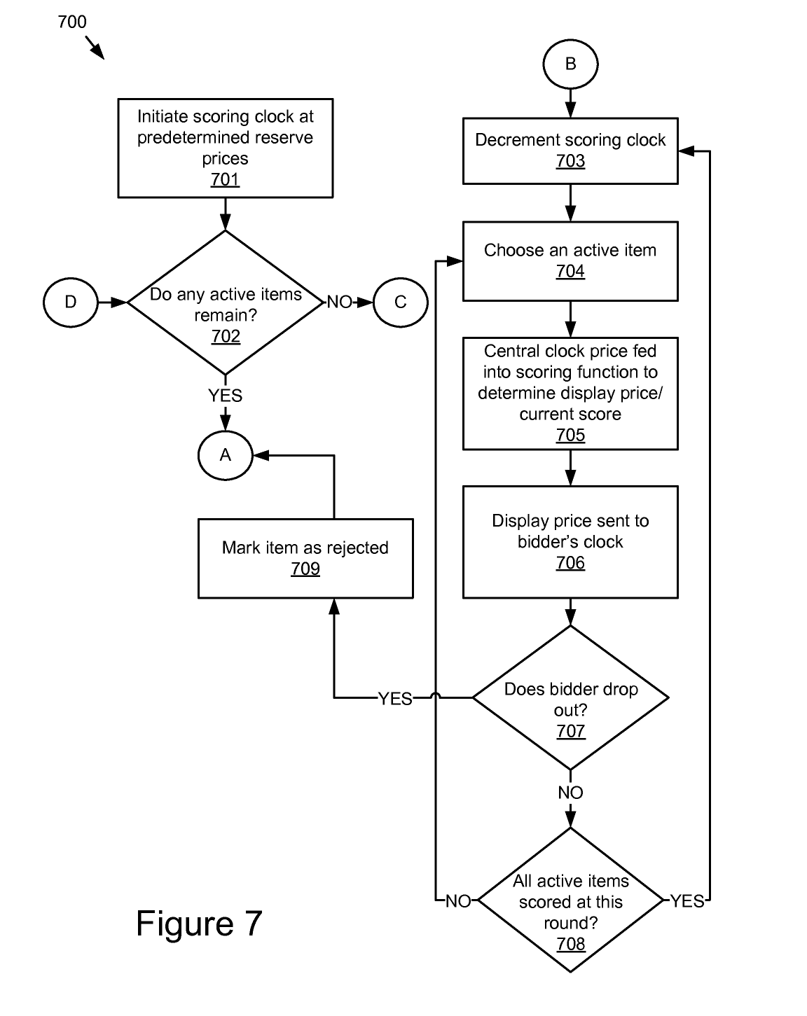

FIG. 5B describes an example auctioneer's process indicated generally by reference numeral 522 for conducting a sealed-bid auction. Before the auction is initiated, the process begins at block 524, at which stage the auctioneer first performs one or more operations for specifying constraints including, but not limited to, items' reserve prices, the available supply of items, and the conditions under which the auction may end. The process 522 then proceeds to block 526, including one or more operations for implementing a method 700 (described in detail in FIG. 7 below) to determine allocations and prices for the items. The process 522 then proceeds to a decision block 528 (including one or more operations) at which stage, if the constraints specified by the auctioneer in block 524 are met or satisfied, the process 522 proceeds to a point 531 at which the auction ends. If the constraints are not met or satisfied, the process 522 proceeds to block 532 (including one or more operations), at which point the auctioneer relaxes the constraints (e.g. revises the constraints or ends the conditions), and then the process 522 returns to block 526.

FIG. 5C is a flowchart illustrating an example bidder process indicated by reference numeral 533 for conducting a sealed-bid auction. Before the auction is initiated, the process 533 begins at block 534, at which point the bidder performs one or more operations for determining the minimum acceptable price at which it would be willing to sell its item. Then, the process 533 proceeds to the next block 536, at which stage the process submits the bid information or reports this minimum price to the auctioneer.

FIG. 5D is a flowchart illustrating an example bidder process for a dynamic auction indicated generally by reference numeral 535. Before the auction is initiated, the process 535 begins at block 538, at which stage, the bidder first conducts one or more operations for determining the minimum price at which it would be willing to sell its item, that is, a minimum acceptable price. Then, the process 535 proceeds to decision block 540, at which stage it receives the current clock price from the auctioneer. From there, the process 535 proceeds to the next decision block 542, including one or more operations by which the bidder determines whether its own minimum price is higher than the current clock price. If the answer is “yes,” the bidder proceeds to a point 544 and drops out of or exits the auction. If the answer is “no,” the bidder returns to decision block 540 to repeat the process for the new current clock price (that is, the price offered in the subsequent round).

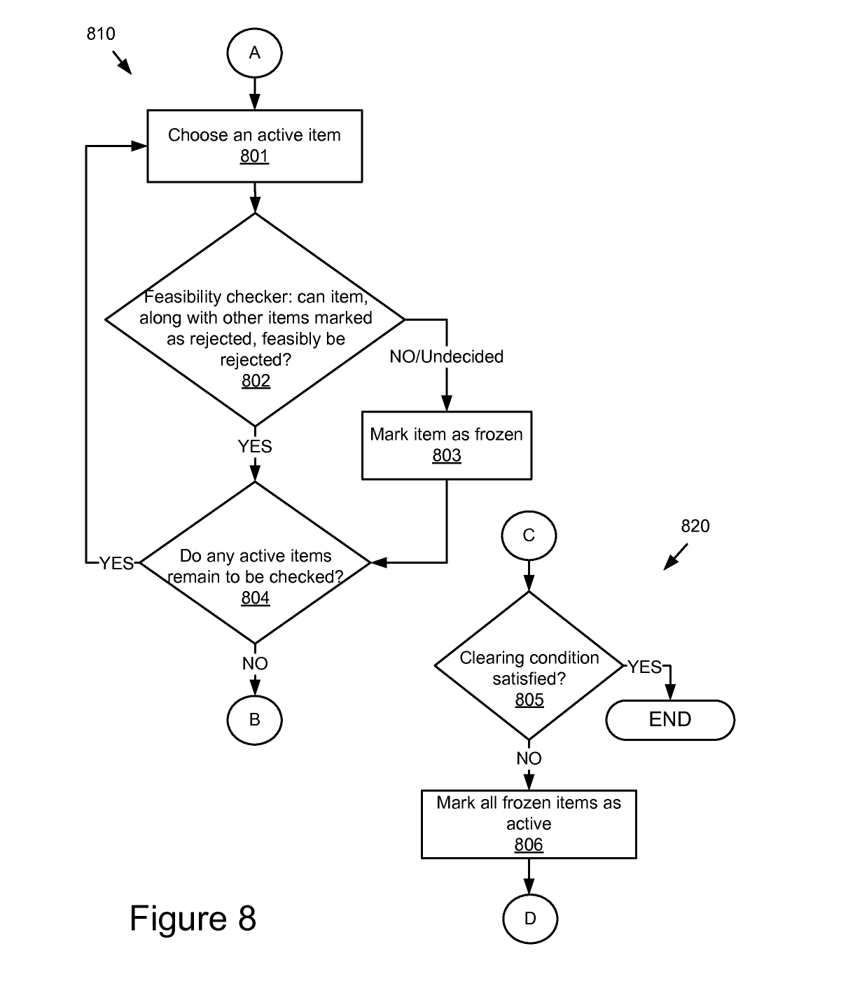

Referring now to FIGS. 6 and 8 together, a “sealed-bid reverse” auction is illustrated, in which a bid for an item may be a dollar amount that is the minimum price that the seller will accept for that item. To determine the winning bids and the corresponding threshold prices, the auction system algorithm processes the bids iteratively. The auction maintains a database in which each item is marked as being in one of three mutually exclusive states: “active,” “frozen,” or “rejected.” Initially, the method 600 begins with one or more operations illustrated by block 601, which indicates that all items are marked as “active” and the provisional threshold price for each item is its maximum price, also known as its reserve price. The method 600 proceeds to a decision block 602, which includes one or more operations for checking whether any items are marked as “active.” In the event no items are marked as “active,” the method 600 proceeds via connector point “C” to another decision block 805 (in FIG. 8), which includes one or more operations for determining if clearing conditions are satisfied. Referring now to FIG. 8, from that point, if the method 600 (indicated by reference numeral 820 in FIG. 8) determines that the clearing conditions are satisfied, the method 600 (820 in FIG. 8) proceeds to a point at which the auction ends. If the method 600 determines that the clearing conditions are not satisfied, the method 600 proceeds to a point 806, where all frozen items are marked as “active,” after which the auctioneer relaxes the constraints used by the feasibility checker, and the method 600 returns to block 602 (FIG. 6) via a connection point “D.” Conducting such a “test” and “return” may be useful when, for example, the clearing condition is that the total prices in the auction do not exceed the auctioneer's budget. If one or more operations of decision block 602 return a “yes,” then the method 600 proceeds to a connection point “A,” leading to FIG. 8, which applies a feasibility checker, starting with step 801 (FIG. 8), which selects an active item. Referring now to FIG. 8, the method 600 (810 in FIG. 8) proceeds to the next decision block 802, which includes one or more operations for inquiring whether any feasible allocation exists in which that item, along with the other items currently marked as “rejected,” are all in fact rejected. The feasibility checker returns an answer of “yes,” “no” or “undecided,” where undecided means that the feasibility checker cannot decide the question in the time allowed. If the feasibility checker answers “no” or “undecided,” then, in block 803, that item is marked as frozen. For complex auction problems, the time required for this feasibility-checker function may be reduced by using parallel processing operations, for example, by allowing feasibility for each item to be checked by a separate computer processor, with all processors working in parallel. The method 600 (810) proceeds to decision block 804, where one or more operations ask whether all “active” items have been checked for feasibility. If so, the method 600 (810) returns to block 801 (FIG. 8). If not, the method 600 proceeds to block 603, via a connection point “B,” where one or more operations of block 603 choose an active item. From there, the method 600 proceeds to the next block 604, where one or more operations compute a score for the item using a scoring function. The computed score may be an increasing function of the bid price for that item and may also depend on (1) the item identifier for that bid, (2) the set of identifiers for all other items (3) the identifiers and bid prices for items marked as rejected, and (4) the identifiers and threshold prices of the items marked as frozen. Factors (2)-(4) are called the additional scoring variables, and the score is therefore described by Score=ƒ(Price Bid for Item, Item Identifier, Additional Scoring Variables), which may be increasing in its first argument. For complex auction problems, the time required for this scoring step may be reduced by using parallel processing operations in the same way as described for the feasibility checker above. Alternatively, each call to the feasibility checker can use factors (1)-(4) to return both a feasibility check and a score. The method 600 proceeds to a decision block 605 to determine if all items are scored. If the answer is “Yes,” the method proceeds to the next block 606, where one or more operations of the method 600 may accord a “High” designation, which is the highest score accorded among the active items. If the answer is “No,” the method 600 returns to block 603. The method 600 proceeds to block 607, where one or more operations mark the highest scoring item as “rejected.” In the event there are multiple highest scoring items, the block 606, using a tie-breaking rule, selects only one of them, and then marks that item as “rejected.” The tie-breaking rule may be random, or alternatively, it may be based on the item identifier, or the time stamp of the associated bid, or any other factor. The method 600 proceeds to block 608, where one or more operations select an active item. The method 600 proceeds to the next block 609, where one or more operations calculate a provisional threshold price for an item as the highest price that generates a score not exceeding “High.” In some implementations, the method 600 determines the highest bid price “B” such that ƒ(B, Item Identifier, Additional Scoring Variables) does not exceed the “High” designation, and sets the provisional threshold price for that item equal to the smaller of B or the existing provisional threshold price. The method 600 proceeds to the next decision block 610, where one or more operations ask whether all active items have had their provisional threshold prices set. If not, the method 600 returns to block 608. If so, the method 600 proceeds to a point at which the iteration is complete and the method 600 returns to decision block 602 to begin the next iteration.

In the preceding paragraphs, a finite procedure is described, which eventually results in all items being marked as either “frozen” or “rejected.” The bids associated with the frozen items at the end of the auction may ultimately become the winning bids, and the provisional threshold prices may become the threshold prices. Alternatively, there may be an auction-ending condition, such as a test to check whether the total prices to be paid in the auction are too high. If the ending condition is not satisfied, then the item processing continues as follows: the constraints to be used by the feasibility checker may be relaxed, all the frozen items marked as active, and the iterations described above continue, beginning at decision block 602.

In the event winning items in a sealed-bid reverse auction are chosen using the reverse greedy heuristic and in the event prices paid to sellers are set to equal the threshold prices, then the auction is strategy-proof for bidders with just one item for sale and may also be strategy-proof or nearly so for other bidders. The sealed-bid auction using the reverse greedy heuristic and threshold pricing has a corresponding dynamic implementation as a clock auction. When all sellers have a single item to sell, this implementation is nearly strategically equivalent to the sealed-bid auction and implements the same scoring function ƒ and the same reserve prices.

Referring now to FIG. 7 in combination with FIG. 8, a corresponding dynamic auction is described where the method for conducting it is indicated generally by reference numeral 700. The method 700 begins at block 701, where one or more operations of the auction first determines a score for each identified item offered by any seller according to Score=ƒ(Reserve Price, Item Identifier, Additional Scoring Variables). The largest of these scores among all items is the “Initial” Score. The Scoring Clock, which is not displayed to the bidders, starts at the Initial Score. The method 700 proceeds to decision block 702, where one or more operations check whether any items are marked as “active” or “remaining.” If decision block 702 returns a “no,” the process 700 proceeds to decision block 805 (in FIG. 8, which is designated by 820) asks whether the auctioneer's clearing condition has been satisfied and, if so, ends the procedure at block 807 (in FIG. 8). If the clearing condition has not been satisfied, all “frozen” items are marked as “active,” and the auctioneer relaxes the constraints used by the feasibility checker, and the method 700 (820) returns to decision block 702 (FIG. 7). Such a test and return may be useful when, for example, the clearing condition is that the total prices in the auction do not exceed the auctioneer's budget. In the event decision block 702 returns a “yes,” then the process 700 applies a feasibility checker, via a connection point “A,” leading to FIG. 8, starting at block 801, to each active item to determine whether there exists any feasible allocation in which the item, along with all the other items currently marked as “rejected,” is rejected. The method 700 (810) proceeds to decision block 802, where the feasibility checker returns an answer of “yes,” “no” or “undecided,” where “undecided” means that the feasibility checker cannot decide the question in the time allowed. In the event the feasibility checker answers “no” or “undecided,” then, in block 803, that item is marked as “frozen.” The method 700 (810) then proceeds to decision block 804 (FIG. 8), where one or more operations of the method 700 (810) ask whether all active items have been processed by the feasibility checker. If so, the method 700 (810) returns to block 801 (FIG. 8) to choose the next active item. If not, the method 700 (via connector B) continues to block 703, at which point the Scoring Clock is decremented. The method 700 proceeds to block 704, where one or more operations choose an active item. The method 700 proceeds to the next block 705, where one or more operations of the method 700 process the active item with a scoring function, computing a price (or range of prices) to be displayed for that item. From there, the method 700 proceeds to the next block 706, where one or more operations send the new display price to the bidder's clock. The new price is the smaller of the last displayed price for that item or the highest price B such that ƒ(B, Item Identifier, Additional Scoring Variables) does not exceed the score on the Scoring Clock. For items marked “frozen” or “rejected,” the display price is unchanged from the previous round. At any time during the auction, if the price for a displayed item has changed from the previous round, the corresponding bidder may elect to reject that price for that item. The method 700 proceeds to the next decision block 707, where one or more operations ask whether the bidder chooses to reject the new display price and exit the auction. If so, then, the method 700 proceeds to the next block 709, where one or more operations of the method 700 change the state of the item in the database to “rejected,” and from there, the method 700 returns (via connector A) to step 801 (the feasibility checker). If not, then the method 700 proceeds to the next decision block 708, which asks whether all active items have been scored. If not, the method 700 returns to block 704, to choose the next item for scoring. If so, the method 700 returns to block 703, where one or more operations decrement the scoring clock to begin the next round.

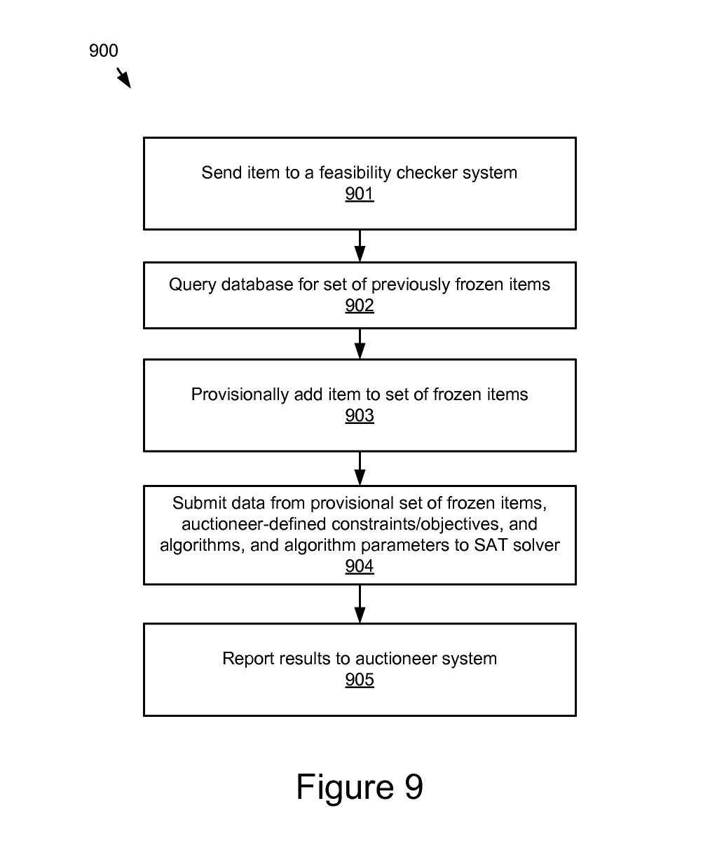

FIG. 9 is a flow chart illustrating an example feasibility-checking process 900 for each item, at each iteration of a sealed-bid auction or each round of a dynamic auction. The process 900 includes one or more operations at block 901 that are configured to send an item to a feasibility checker system. The method 900 proceeds to the next block 902, which includes one or more operations configured to query the database for a set of previously “frozen” items. The process 900 proceeds to the next block 903, which includes one or more operations configured to provisionally add an item to a set of “frozen” items. From there, the process 900 proceeds to the next block 904 including one or more operations that are configured to submit data from a provisional set of frozen items, auctioneer-defined constraints/objectives, and algorithm parameters to SAT solver. The process 900 proceeds to the next block 905, which includes one or more operations configured to report results to the auctioneer system.

The reverse auctions described above may be adjusted in various ways to suit particular circumstances. One adaptation takes account of bidders' desires to know more about others' prices by supplying additional information, such as information about others' bids, to bidders during the course of the dynamic version of the auction. This may be done without changing the winner-determination procedure or the threshold-pricing rules. A second adaptation allows bidders to make combinatorial bids instead of bids on single items. That may be implemented, for example, by describing the combination in the item identifier and requiring bidders to list each item only once, in either a standard bid or a combinatorial bid.

A third adaptation may be useful when sellers wish to make multiple bids, some of which include non-cash elements. For example, a television broadcaster may offer to sell its UHF television broadcast license in exchange either for a certain amount of cash or for a smaller amount of cash plus a VHF television broadcast license. The dynamic threshold auction that incorporates non-cash elements displays multiple prices, with one corresponding to each of the selling options that the bidder may wish to offer. At each round or iteration, each bidder would specify not merely whether to accept its price for its item or to exit but also, if the bidder does not exit, which option it prefers (e.g. channel-sharing, switching to a VHF frequency, etc.) at the several displayed prices. In all such auctions, bidders may exit only if the offered price for their preferred option is reduced. The winning items are the ones for which there is no exit during the auction, and the price paid to a winner for its preferred option is the price displayed for that item and option at the end of the auction. The heuristic used for setting prices may be tailored to the nature of the bids and to the constraints that they imply. For example, if there is a limited number of VHF licenses that may be offered to broadcasters selling UHF licenses, then the feasibility checker and clock-pricing rule would need to reflect that adaptation.

Some examples of Bid Database configurations are illustrated below, in particular a Bid Database configuration for Sealed-Bids and a Bid Database configuration for Dynamic Bidding:

Bid Database (Sealed Bids)

| (1) | (2) | (3) | (4) | (5) | . . . |
|---|---|---|---|---|---|
| Item ID | Bid State | Threshold Price | Bid Amount | Score | . . . |
| 001 | Active | P1 | X1 | S1 | |
| 002 | Frozen | P2 | X2 | S2 | |
| 003 | Rejected | P3 | X3 | S3 | |
| . . . | | | | | |

Bid Database (Dynamic Bidding)

| (1) | (2) | (3) | . . . |
|---|---|---|---|
| Item ID | Bid State | Display Price | . . . |
| 001 | Active | P1 | |
| 002 | Frozen | P2 | |
| 003 | Rejected | P3 | |
| . . . | | | |

It is clear that many modifications and variations of these embodiments or implementations may be made by one skilled in the art without departing from the spirit of the novel art of this disclosure. For example, depending on the auction, the entity that holds or conducts the auction, and the entity that takes the bids to buy and sell, different rules may be published and hence used in a rules-and-constraints engine to resolve those bids. These modifications and variations do not depart from the broader spirit and scope of the invention, and the examples cited here are to be regarded in an illustrative rather than a restrictive sense. The approach described here can be used both online and, in simple cases, offline. Also, sellers might be limited to a single offer, or, in more commoditized situations, many bids, sometimes in regular time intervals, sometimes as a one-time or occasional auction.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A computer-implemented auction system comprising
a) an auctioneer system, further comprising;
1) a first processor:
2) first memory storing instructions that cause the first processor to execute operations to conduct an auction;
3) a communication interface unit coupled to the first processor and the first memory and configured to receive and transmit bid information and messages relating to the auction; and
the first memory configured to store at least the bid information in one or more databases associated with the auctioneer system;
b) one or more feasibility-checker systems coupled to the auctioneer system, and further comprising:
1) a second processor; and
2) second memory storing instructions that cause the second processor to execute feasibility-checker operations on each bid item in the auction, the feasibility-checker operations including 1) one or more operations to test a first decision for all bid items in the auction within an allotted period of time, to indicate a status, including at least one of a feasible and not feasible status for at least certain bid items, and 2) one or more operations for determining whether the first decision and at least one other second decision relating to the implementation of the first decision jointly satisfy a set of constraints specified with respect to the auction;
c) a bid-entry system coupled to at least one of the auctioneer system and the one or more feasibility-checker systems, and configured to transmit to the auctioneer system, at least one of 1) the bid information collected from bidders participating in the auction when it is in a sealed-bid auction and 2) exit decisions by bidders in the auction when it is a dynamic auction, and the bid-entry system further configured to receive at least one of auction results and messages for the bidders participating in the sealed-bid auction and current price information for the dynamic auction operated by the auctioneer system, the bid-entry system configured to receive and transmit information and messages to the auctioneer system.

2. The system of claim 1 wherein the feasibility-checker system test operations indicate the feasible status for at least certain bid items, the not feasible status for at least certain bid items, and an undecided status for at least certain bid items.

3. The system of claim 1 wherein the feasibility-checker system comprises:
an array of one or more computing systems, each comprising one or more processors and memories including the second processor and the second memory and configured for parallel processing to implement the feasibility-checking operation at any given round in the dynamic auction or iteration in the sealed-bid auction.

4. The system of claim 1 wherein prices for items for auction are set based on a threshold pricing rule.

5. A computer-implemented sealed-bid auction method, comprising:
a) initiating an auction, including collecting bid/item information from one or more bidders,
b) entering bid/item information in one or more databases,
c) evaluating updated information and determining whether the auction should end and, in the event a determination concludes that the auction should not end, generating updated provisional price or allocation decisions based on current information in the one or more databases, by performing the following operations:
using a feasibility-checking process to evaluate each item at each round or iteration to provisionally determine whether the item can feasibly be included in the final allocation and, if so,
using a scoring-function process to determine for each item at each round or iteration whether in a sealed-bid auction, the item should be rejected and not included in the final allocation or in a dynamic auction what price should next be offered to the bidder,
d) communicating updated information or final messages to the one or more bidders, and
e) repeating select operations from among the above operations until it is determined that the auction should conclude.

6. The method of claim 5 wherein the feasibility-checking process uses a satisfiability solver component.

7. The method of claim 5 wherein the feasibility-checking process further comprises:
performing parallel processing operations at any given round in the dynamic auction or iteration in the sealed-bid auction.

8. The method of claim 5 wherein prices for items are set based on a threshold pricing rule.

9. A computer-implemented dynamic auction method, comprising:
a) initiating an auction, including collecting bid/item information from one or more bidders,
b) entering bid/item information in one or more databases,
c) evaluating updated information and determining whether the auction should conclude and, if a determination is made that the auction should not conclude, generating at least one of an updated provisional price and an allocation decision based on current information in one or more databases, by performing the following operations:
using a feasibility-checking process to evaluate each item at each round or iteration to provisionally determine whether the item can feasibly be included in the final allocation and, if so,
using a scoring-function process to determine for each item at each round or iteration whether, in a sealed-bid auction, the item should be rejected and not included in the final allocation or, in a dynamic auction, what price should next be offered to the bidder,
d) communicating at least one of updated information and final messages to the one or more bidders, and
e) repeating operations selected from among the above until it is determined that the auction should conclude.

10. The method of claim 9 wherein the feasibility-checker process uses a satisfiability solver component to evaluate feasibility.

11. The method of claim 9 wherein the feasibility-checking process further comprises:
performing parallel processing operations at any given round in the dynamic auction or iteration in the sealed-bid auction.

12. The method of claim 9 wherein prices for items are set based on a threshold pricing rule.
